(19) United States
(12) Patent Application Publication
(10) Pub. No.: US 2022/0207436 A1
(43) Pub. Date: Jun. 30, 2022

(54) SYSTEM FOR PURCHASING OR RESERVING WINE, AND METHOD AND PROGRAM IMPLEMENTED IN SAID SYSTEM

(71) Applicant: Broadedge Warelink Inc., Tokyo (JP)

(72) Inventor: Eishi MARUOKA, Tokyo (JP)

(21) Appl. No.: 17/615,100

(22) PCT Filed: Apr. 8, 2020
(86) PCT No.: PCT/JP2020/015790

§ 371 Date: Nov. 30, 2021

(30) Foreign Application Priority Data
May 30, 2019 (JP) 2019-101264

(51) Int. Cl. G06Q 10/02; G06Q 30/06

(52) U.S. Cl. CPC G06Q 10/02; G06Q 30/0631; G06Q 30/0643

(57) ABSTRACT

This system of the present invention comprises a means of presenting a user with information of a plurality of wines, a means of receiving first user input selecting one among the plurality of wines, a means of presenting the user with information of one or more stores corresponding to the selected wine, a means of receiving second user input selecting one among the one or more stores, and a means of performing processing for purchasing or reserving the selected wine in order to provide the user with the selected wine in the selected shop in response to receiving the second user input.

### TECHNICAL FIELD

The present invention is directed to a system for purchasing or reserving wine and a method and a program implemented in said system.

### BACKGROUND ART

Websites for reserving stores such as a restaurant have been known (see, for example, Non Patent Literature 1).

### CITATION LIST

### Non Patent Literature

[NPL 1] Gurunavi, Inc., “Enkai/gurume joho kensaku saito Gurunavi (Feast/gourmet information search site Gurunavi)”, [online], [retrieved on May 15, 2019], Internet <URL: https://www.gnavi.co.jp/>

### SUMMARY OF INVENTION

### Technical Problem

In a conventional website for reserving a store, even if there was wine that a user wants to drink, it was not possible to use the wine that the user wants to drink as a criterion to search a store that can provide the wine that the user wants to drink. Thus, there was the problem of a user needing to check each time whether or not a store has the wine that the user wants to drink among the wine that can be provided in the store after searching the store, and the problem of a user realizing that a store does not store the wine that the user wants to drink only after visiting the store that the user reserved.

One object of the present invention is to provide a system that enables a user to purchase or reserve wine and a method and a program implemented in said system so as to enable the user to drink the wine that the user wants to drink in a store that the user reserve.

### Solution to Problem

In one aspect of the present invention, the system of the present invention is a system for purchasing or reserving wine, the system comprising: a means of presenting a user with information of a plurality of wines; a means of receiving first user input selecting one among the plurality of wines; a means of presenting the user with information of one or more store corresponding to the selected wine; a means of receiving second user input selecting one among the one or more store; and a means of performing a processing for purchasing or reserving the selected wine in order to provide the user with the selected wine in the selected store in response to receiving the second user input.

In one embodiment of the present invention, a means of performing a processing for reserving the selected store may be further comprised.

In one embodiment of the present invention, the processing for reserving the selected store may comprise a processing for reserving the selected store which assumes carry-in of the selected wine to the selected store or a processing for reserving the selected store which assumes delivery of the selected wine to the selected store.

In one embodiment of the present invention, the processing for reserving the selected store may comprise: a processing for determining whether or not the selected wine is present in storage of the selected store; a processing for setting aside the selected wine at the selected store when it is determined that the selected wine is present in storage of the selected store; and a processing of reserving the selected store which assumes that the selected wine is provided in the selected store.

In one embodiment of the present invention, the one or more store corresponding to the selected wine may comprise one or more store that can provide the user with food that matches with the selected wine.

In one embodiment of the present invention, a means of presenting information of one or more food that matches with the selected wine in response to receiving the first user input; and a means of receiving third user input selecting one among the one or more food may be further comprised, wherein the means of presenting the user with information of one or more store corresponding to the selected wine may comprise: a means of presenting the user with information of one or more store that can provide the user with the selected food in response to receiving the third user input.

In one embodiment of the present invention, the plurality of wines may comprise a plurality of wines at least owned by a wholesaler which sets a plurality of stores as wholesale destinations; and the plurality of stores may comprise the one or more store.

In one embodiment of the present invention, the plurality of wines at least owned by the wholesaler may comprise wine owned by the wholesaler and wine owned by a stocking dealer that is a stocking destination of the wholesaler.

In one embodiment of the present invention, a means of updating information of the plurality of wines presented to the user in real time may be further comprised.

In one embodiment of the present invention, a means of receiving information of wine consumed by the user in the reserved store, wherein the wine consumed by the user comprises the purchased or reserved wine and wine carried in the reserved store or wine delivered to the reserved store or wine present in storage of the reserved store; and a means of performing a processing for assessing consumption trend of wine based on the information of wine consumed by the user may be further comprised.

In one aspect of the present invention, the method of the present invention is a method performed in a system for purchasing or reserving wine, wherein the system comprises a processor part, wherein the method comprises: the processor part presenting a user with information of a plurality of wines; the processor part receiving first user input selecting one among the plurality of wines; the processor part presenting the user with information of one or more store corresponding to the selected wine; the processor part receiving second user input selecting one among the one or more store; and the processor part performing a processing for purchasing or reserving the selected wine in order to provide the user with the selected wine in the selected store in response to receiving the second user input.

In one aspect of the present invention, the program of the present invention is a program performed in a system for purchasing or reserving wine, wherein the system comprises a processor part, wherein when performed by the processor part, the program causes the processor part to at least perform: presenting a user with information of a plurality of wines; receiving first user input selecting one among the plurality of wines; presenting the user with information of one or more store corresponding to the selected wine; receiving second user input selecting one among the one or more store; and performing a processing for purchasing or reserving the selected wine in order to provide the user with the selected wine in the selected store in response to receiving the second user input.

In one aspect of the present invention, the system of the present invention is a system for purchasing or reserving wine, the system comprising: a means of presenting a user with information of a plurality of stores; a means of receiving first user input of selecting one among the plurality of stores; a means of presenting the user with information of one or more bottle of wine corresponding to the selected store in response to receiving the first user input; a means of receiving second user input selecting one among the one or more bottle of wine; and a means of performing a processing of reserving the selected store and the selected wine in order to provide the user with the selected wine in the selected store in response to receiving the second user input.

In one embodiment of the present invention, the one or more bottle of wine corresponding to the selected store may comprise one or more bottle of wine present in storage of the selected store.

In one embodiment of the present invention, the one or more bottle of wine corresponding to the selected store may comprise one or more bottle of wine at least owned by a wholesaler which sets a plurality of stores as wholesale destinations.

In one embodiment of the present invention, wherein the one or more bottle of wine at least owned by the wholesaler may comprise wine owned by the wholesaler and wine owned by a stocking dealer that is a sticking destination of the wholesaler.

In one embodiment of the present invention, a means of updating information of the one or more bottle of wine presented to the user in real time may be further comprised.

In one embodiment of the present invention, a means of receiving information of wine consumed by the user in the reserved store, wherein the wine consumed by the user comprises the selected wine and wine carried in the reserved store or wine delivered to the reserved store or wine present in storage of the reserved store; and a means of performing a processing for assessing consumption trend of the purchased or reserved wine based on the information of wine consumed by the user may be further comprised.

In one aspect of the present invention, the method of the present invention is a method performed in a system for purchasing or reserving wine, wherein the system comprises a processor part, wherein the method comprises: the processor part presenting a user with information of a plurality of stores; the processor part receiving first user input selecting one among the plurality of stores; the processor part presenting the user with information of one or more bottle of wine corresponding to the selected store in response to receiving the first user input; the processor part receiving second user input selecting one among the one or more bottle of wine; and the processor part performing a processing for reserving the selected store and the selected wine in order to provide the user with the selected wine in the selected store in response to receiving the second user input.

In one aspect of the present invention, the program of the present invention is a program performed in a system for purchasing or reserving wine, wherein the system comprises a processor part, wherein, when performed by the processor part, the program causes the processor part to at least perform: presenting a user with information of a plurality of stores; receiving first user input selecting one among the plurality of stores; presenting the user with information of one or more bottle of wine corresponding to the selected store in response to receiving the first user input; receiving second user input selecting one among the one or more bottle of wine; and performing a processing for reserving the selected store and the selected wine in order to provide the user with the selected wine in the selected store in response to receiving the second user input.

### Advantageous Effects of Invention

According to the present invention, it is possible to provide a system that enables a user to purchase or reserve wine and a method and a program implemented in said system so as to enable the user to drink the wine that the user wants to drink in a store that the user reserved.

### BRIEF DESCRIPTION OF DRAWINGS

FIG. 1 A diagram showing the flow of a new business model utilizing purchase/reservation of wine.

FIG. 2A A diagram showing a screen 200 displayed on a user apparatus.

FIG. 2B A diagram showing a screen 210 displayed on a user apparatus.

FIG. 2C A diagram showing a screen 220 displayed on a user apparatus.

FIG. 2D A diagram showing a screen 230 displayed on a user apparatus.

FIG. 2E A diagram showing a screen 240 displayed on a user apparatus.

FIG. 2F A diagram showing a screen 250 displayed on a user apparatus.

FIG. 2G A diagram showing a screen 260 displayed on a user apparatus.

FIG. 3 A diagram showing an example of a configuration of a computer system for realizing the above-mentioned new business model.

FIG. 4A A diagram showing an example of a configuration of information housed in a wine database part 341.

FIG. 4B A diagram showing an example of configuration of information housed in a store database part 342.

FIG. 5 A diagram showing an example of the flow of the processing implemented in a computer system 300.

FIG. 6 A diagram showing another example of the flow of the processing implemented in a computer system 300.

FIG. 7 A diagram showing an example of the flow of the processing implemented in a computer system 300.

FIG. 8 A diagram showing an example of the flow of the processing implemented in a computer system 300.

### DESCRIPTION OF EMBODIMENTS

The embodiment of the present invention is explained below while referring to the drawings.

### 1. A New Business Model Utilizing Purchase/Reservation of Wine

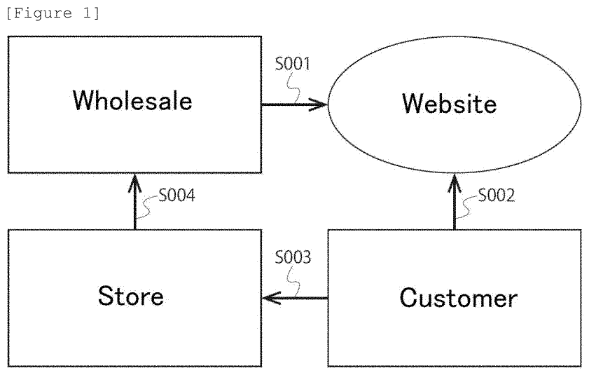

FIG. 1 shows the flow of a new business model utilizing purchase/reservation of wine. Each step of this flow is explained below in detail.

Step S001: A wholesaler inserts information of wine owned by the wholesaler and information of stores which are the wholesale destinations of the wholesaler in a website. The information of wine is, for example, but not limited to, wine brand, type, production area, vintage, body, price, food that matches with the wine and the like. The information of stores is, for example, but not limited to, store name, address, genre, business hours, access method, wine list, information showing whether or not it is possible to carry in wine, information showing whether or not it is possible to directly deliver wine and the like.

Step S002: A customer uses a user apparatus to access the information of wine inserted in the website. The customer can identify the wine that he/she wants to drink by accessing the information of wine. Next, the customer uses the user apparatus to access the information of stores inserted in the website. This information of stores is, for example, but not limited to, information of stores having the wine identified by the customer in storage, information of stores in which the customer can carry in the wine that the customer identified, information of stores in which the wine that the customer identified can be directly delivered, information of stores that provide food that matches with the wine that the customer identified and the like. The customer can reserve the store by accessing the information of stores. Furthermore, assuming that the customer will consume the wine that the customer identified at the store, the customer can make reservation of the wine that the customer identified (e.g., setting aside the wine that the customer identified, directly delivering the wine that the customer identified, and carrying in the wine that the customer identified) along with reservation of the store.

In addition, a user ID and a password is required to be registered beforehand in order to enter this website and the user ID and password can be used to allow access to the information of wine and the information of stores.

Step S003: The customer visits the store that was reserved in step S002, consumes the reserved wine and pays the price to the store.

Step S004: The store provides the wholesaler with the advertisement fee for inserting the information of the store in the website, fee for delivery to customer and the like. The store may also provide the wholesaler with data of purchase action/consumption action of wine of customers.

As such, a customer can view all wine owned by the wholesaler at first on the website, and thus can select desired wine among all wine owned by the wholesaler. Therefore, the customer can examine various wine with rich variation without the choices of wine being limited to the storage of the store.

In addition, the customer can view on the website the information of stores providing food that matches with the desired wine that the customer identified and select a store that the customer wants to reserve thereamong. This can more easily realize simultaneous enjoyment of desired wine and food that matches with the desired wine even of the customer did not know the suitability regarding a combination with wine.

In addition, by direct delivery of the wine that the customer identified and/or the customer carrying in the wine that the customer identified, the store can provide the customer with a number of brands and number of storages of wine that the store normally cannot handle. This can achieve improvement in the degree of satisfaction of the customer and increase in the amount of consumption/consumption cost of wine of the customer.

In addition, the wholesaler can receive data of wine purchase behavior/consumption behavior of customers from the store, whereby the wholesaler can attempt optimization of wine stocking, optimization of selection of wine in each store, and the like.

Furthermore, the above-discussed embodiment explained an example of presenting information of wine owned by a wholesaler to a customer, but the present invention is not limited thereto. For example, in step S001, the wholesaler may insert information of wine owned by a stocking dealer (importer) that is the stocking destination of the wholesaler, information of wine owned by the wholesaler and information of stores which are the wholesale destinations of the wholesaler in a website so that a customer can view not only the information of wine owned by the wholesaler, but also information of wine owned by the stocking dealer.

### 2. Screens Displayed on a User Apparatus

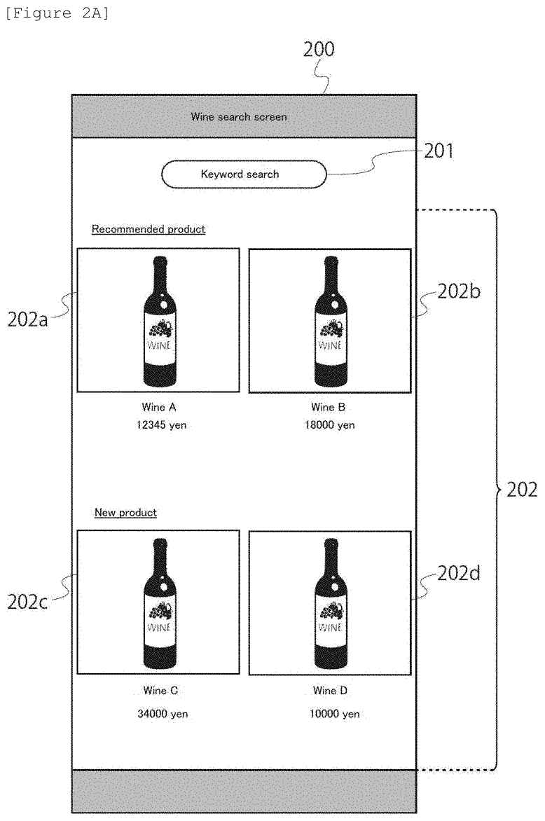

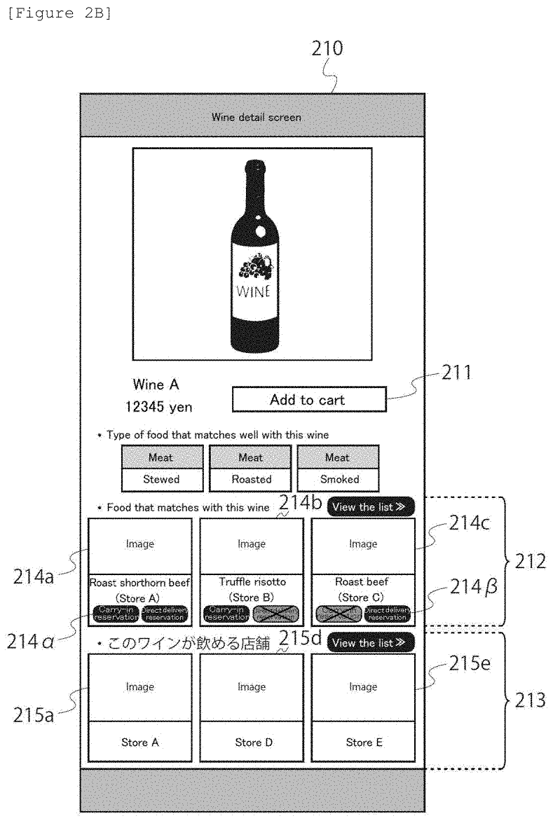

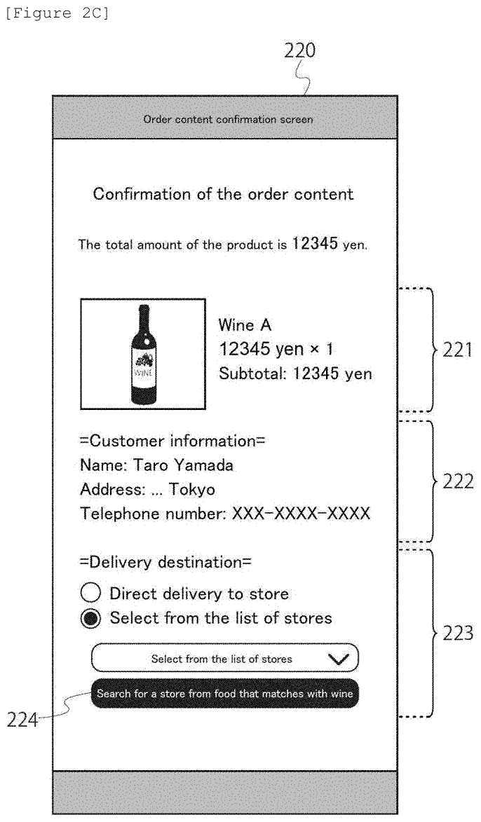

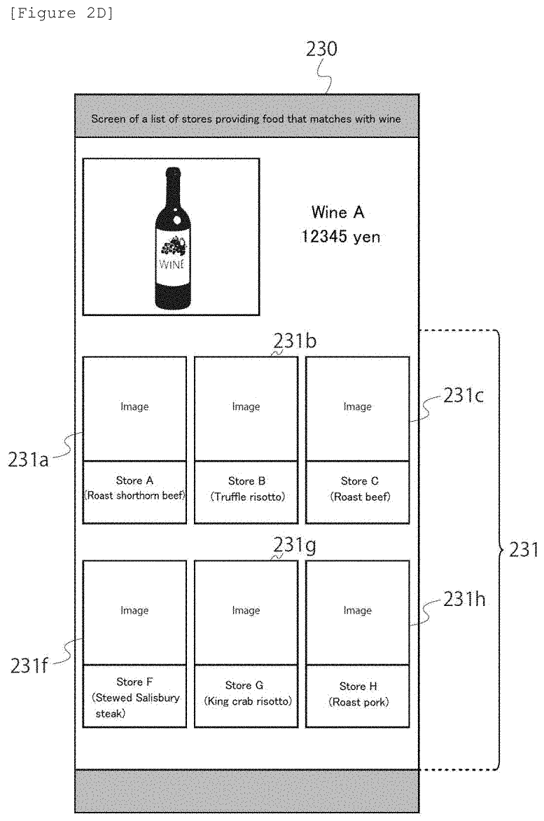

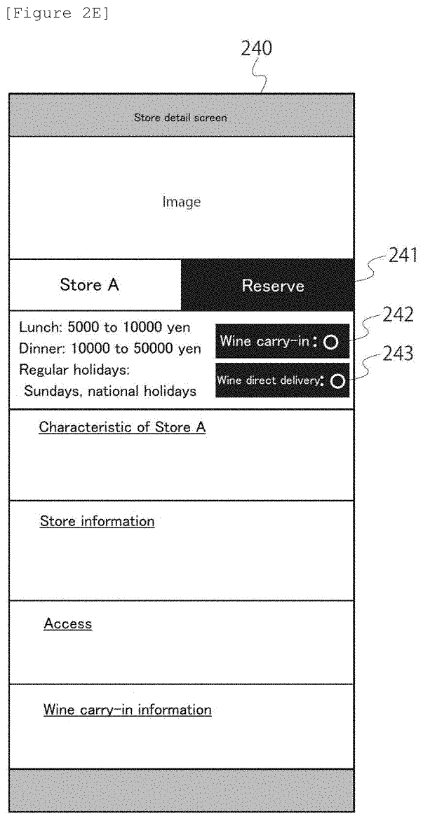

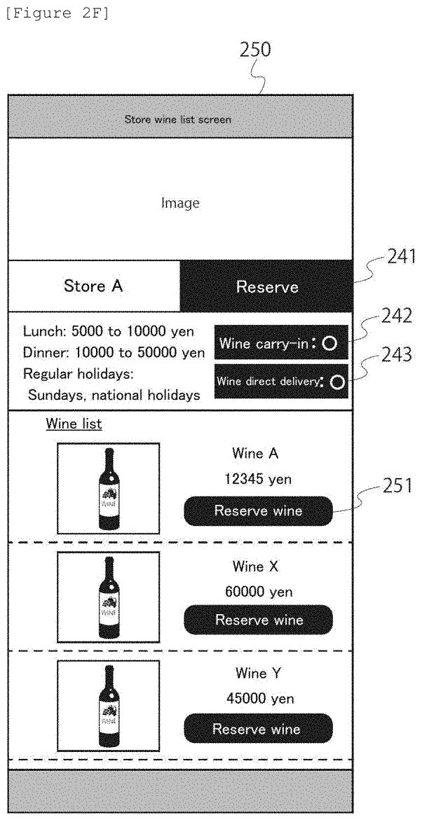

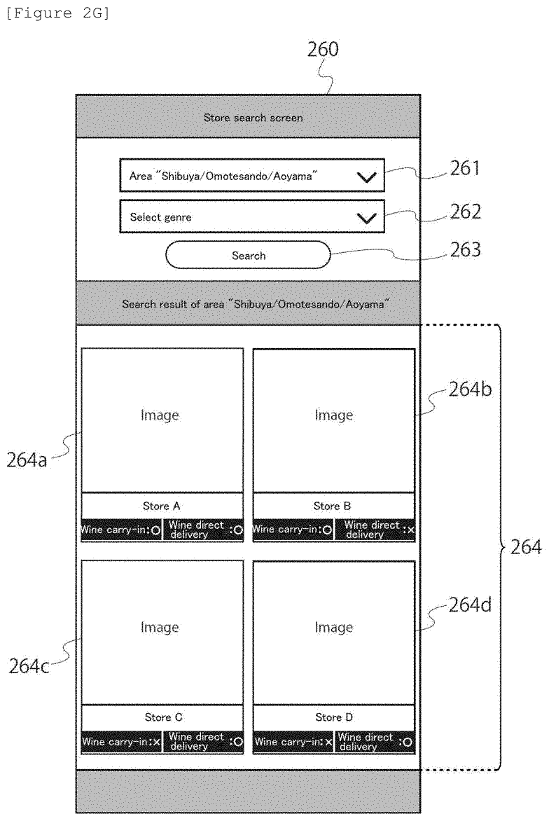

FIG. 2A to FIG. 2G show screens 200 to 260 displayed on a user apparatus. Display and transition of the screens 200 to 260 are achieved by, for example, a program housed in a memory part of a user apparatus being performed by a processor part of the user apparatus. Regarding each of the screens 200 to 260, the entirety thereof does not have to be displayed on the user apparatus. For example, a part of the screen user 200 may be displayed on the user apparatus and another part of the screen 200 may be displayed by carrying out scrolling operation.

FIG. 2A shows a screen 200 displayed on a user apparatus. The screen 200 is an example of a wine search screen for searching desired wine among a plurality of wines. In the example shown in FIG. 2A, the screen 200 comprises a search button 201 for carrying out keyword search and a wine information region 202 displaying a list of information of wine.

When a user selects the search button 201, a screen form inputting a search condition for searching wine is displayed. The user can input a search condition of wine in the screen. The search condition of wine includes, for example, but not limited to, price (e.g., up to 1999 yen, 2000 to 4999 yen, 5000 to 9999 yen, 10000 to 29999 yen, or 30000 yen and above), type (e.g., wine (red), wine (white), wine (rose), or sparkling wine), production area (e.g., France (Burgundy), France (Bordeaux), Italy (Tuscany), Italy (Piemonte), Spain, Germany, America, Australia, Argentina, South Africa, Japan, or China), variety (e.g., Pinot Noir, Cabernet Sauvignon, Merlot, Chardonnay, or Riesling), vintage (e.g., 2010 and after, 2000 to 2009, 1990 to 1999, 1980 to 1989, or 1979 and before), body (e.g., light body, medium body, or full body) and the like.

In the Example shown in FIG. 2A, the wine information region 202 comprises a region 202a showing information of wine A, a region 202b showing information of wine B, a region 202c showing information of wine C and a region 202d showing information of wine D. Each of region 202a to region 202d is configured to be selectable.

In the example shown in FIG. 2A, only recommended products and new products are shown in the wine information region 202. Alternatively, in addition to recommended products and new products, or instead of recommended products and new products, search results of wine produced in response to input of search condition of wine may be displayed on the wine information region 202.

FIG. 2B shows a screen 210 displayed on a user apparatus. The screen 210 is an example of wine detail screen for presenting detailed information of wine. The screen 210 is, for example, a screen that has transitioned from the screen 200 by selecting the region 202a shown in FIG. 2A. In the example shown in FIG. 2B, the screen 210 presents detailed information of wine A. In the example shown in FIG. 2B, the screen 210 comprises an add-to-cart region 211 for adding wine A to the cart and ultimately moving on to purchasing procedures for the wine A, a food information region 212 showing information of food that matches with the wine A and a store information region 213 showing information of stores that provide the wine A.

In the example shown in FIG. 2B, the food information region 212 comprises a region 214a showing information of the food “roast shorthorn beef” that matches with the wine A, a region 214b showing information of the food “truffle risotto” that matches with the wine A and a region 214c showing information of the food “roast beef” that matches with the wine A. In other words, in the example shown in FIG. 2B, “roast shorthorn beef, “truffle risotto” and “roast beef” are mentioned as food that matches with the wine A. In the example shown in FIG. 2B, the region 214a is associated with a store A that can provide the food “roast shorthorn beef”, the region 214b is associated with a store B that can provide the food “truffle risotto” and the region 214c is associated with a store C that can provide the food “roast beef”. In addition, each of the region 214a, the region 214b and the region 214c comprises a carry-in reservation button 214a for making reservation of the store A which assumes carry-in of the wine A to the store A and a direct delivery reservation button 214A for making reservation of the store A which assumes direct delivery of the wine A to the store A. In the Example shown in FIG. 2B, both the carry-in reservation button 214a and the direct delivery reservation button 214P of the region 214a are presented in a selectable mode. This means that the store A is a store that can handle both carry-in of wine and direct delivery of wine. In the example shown in FIG. 2B, while the carry-in reservation button 214a of the region 214b is presented in a selectable mode, the direct delivery reservation button 214P of the region 214b is presented in an unselectable mode. This means that the store B is a store that can handle carry-in of wine but cannot handle direct delivery of wine. In the example shown in FIG. 2B, while the carry-in reservation button 214a of the region 214c is presented in an unselectable mode, the direct delivery reservation button 214P of the region 214c is presented in a selectable mode. This means that the store C is a store that cannot handle carry-in of wine but can handle direct delivery of wine. Furthermore, information of food that matches with the wine A may be presented to a user (e.g., by displaying a list) by the user selecting a “view the list” button in the food information region 212.

In the example shown in FIG. 2B, the store information region 213 comprises a region 215a showing information of a store A that provides wine A, a region 215d showing information of a store D that provides wine A and a region 215e showing information of a store E that provides wine A. Each of the region 215a, the region 215d and the region 215e is configured to be selectable. Furthermore, information of a store that provides the wine A may be presented to a user (e.g., by displaying a list) by the user selecting a “view the list” button in the store information region 213. In addition, information of one or more store presented in the store information region 213 may be information of a store that provides the wine A at a normal time, or may be real-time information of a store that can provide the wine A at that time point.

When the region 214a shown in FIG. 2B, or the carry-in reservation button 214a in the region 214a, or the direct delivery reservation button 2140 in the region 214a is selected by a user, the screen 210 transitions to the screen 240 of FIG. 2E which is discussed below. Alternatively, when the carry-in reservation button 214a in the region 214a is selected by a user, the screen 210 may transition to a screen exclusively for making reservation of the store A which assumes carry-in of the wine A to the store A. Alternatively, when the direct delivery reservation button 214P in the region 214a is selected by a user, the screen 210 may transition to a screen exclusively for making reservation of the store A which assumes direct delivery of the wine A to the store A. The same apples to a case in which the region 214b, the carry-in reservation button 214a in the region 214b, the region 214c, or the direct delivery reservation button 214P in the region 214c is selected by a user.

When the region 215a shown in FIG. 2B is selected by a user, the screen 210 transitions to the screen 250 of FIG. 2F which is discussed below. The same applies to the case in which the region 215d or the region 215e is selected by a user.

FIG. 2C shows a screen 220 displayed on a user apparatus. The screen 220 is an example of an order content confirmation screen for confirming an order content. The screen 220 is, for example, a screen transitioned from the screen 210 by selecting the add-to-cart region 211 shown in FIG. 2B. In the example shown in FIG. 2C, the screen 220 shows that the content of the order is the wine A. In the example shown in FIG. 2C, the screen 220 comprises an order information region 221 showing the content of ordered wine, an orderer information region 222 showing personal information of an orderer (user) and a delivery destination information region 223 showing a delivery destination of ordered wine.

In the example shown in FIG. 2C, order information showing that one bottle of wine A with the price of 12345 yen per bottle is ordered is displayed in the order information region 221 together with the image of the wine A. However, the number or subtotal of the image of the wine displayed in the order information region 221 may change in accordance with the type and number of bottles of the ordered wine. In addition, in the example shown in FIG. 2C, the orderer's name, address and telephone number are displayed in the orderer information region 222 as personal information of the orderer, but the personal information of the orderer displayed in the orderer information region 222 is not limited thereto. In addition, in the example shown in FIG. 2C, it is possible to select the orderer's address or a store as the delivery designation of the ordered wine in the delivery destination information region 223. When a store is selected as the delivery destination or the ordered wine, as shown in FIG. 2C, a store list selection region for selecting a store that is to be the delivery destination from a store list and a food-based selection region 224 for selecting a store that provides food that matches with the wine A are displayed. When the store list selection region is selected, for example, a list of all stores that provide the wine is displayed (e.g., in a pull-down form).

FIG. 2D shows a screen 230 displayed on a user apparatus. The screen 230 is an example of a screen of a list of stores that provide food that matches with the wine. The screen 230 is a screen that has transitioned from the screen 220 by selecting the food-based selection region 224 shown in FIG. 2C. In the example shown in FIG. 2D, the screen 230 presents information of one or more store that provides food that matches the wine A. In the example shown in FIG. 2D, the screen 230 comprises a region 231 displaying a list of information of one or more store that provides food that matches with the wine A.

In the example shown in FIG. 2D, the region 231 comprises a region 231a showing information of a store A that provides the food “roast shorthorn beef” that matches with the wine A, a region 231b showing information of a store B that provides the food “truffle risotto” that matches with the wine A, a region 231c showing information of a store C that provides the food “roast beef” that matches with the wine A, a region 231f showing information of a store F that provides the food “stewed Salisbury steak” that matches with the wine A, a region 231g showing information of a store G that provides the food “king crab risotto” that matches with the wine A and a region 231h showing information of a store H that provides the food “roast pork” that matches with the wine A. Each of the region 231a, the region 231b, the region 231c, the region 231f, the region 231g and the region 231h is configured to be selectable.

FIG. 2E shows a screen 240 displayed on a user apparatus. The screen 240 is an example of a store detail screen for presenting detailed information of a store. The screen 240 is, for example, a screen that has transitioned from the screen 230 by selecting the region 231a shown in FIG. 2D. In the example shown in FIG. 2E, the screen 240 presents detailed information of the store A. In the example shown in FIG. 2E, the screen 240 comprises a reservation button 241 to proceed to make reservation of the store A, wine carry-in information 242 showing whether or not wine can be carried in and wine direct delivery information 243 showing whether or not wine can be directly delivered. The screen 240 may further comprise a region showing information showing the characteristic of the store A, basic information of the store A (e.g., address), information showing a method of access to the store A, information regarding carry-in of wine to the store A and the like.

In the Example shown in FIG. 2E, the reservation button 241 is configured to be selectable. The screen 240 transitions to a screen for performing reservation of the store A by a user selecting the reservation button 241.

In the example shown in FIG. 2E, the wine carry-in information 242 shows “∘”. This means that carry-in of wine to the store A is possible. In addition, in the example shown in FIG. 2E, the wine direct delivery information 243 shows “∘”. This means that direct delivery of wine to the store A is possible.

Furthermore, after a screen ultimately transitions from the screen 220 of FIG. 2C to the screen 240 of FIG. 2E via the screen 230 of FIG. 2D, when a user completes the reservation of the store, the order of the wine in the screen 220 of FIG. 2C would be automatically fixed. This enables the wine A to be delivered to the store so that the user can drink the wine A at the store on the store reservation date.

In addition, when the screen transitioned from the screen 210 of FIG. 2B to the screen 240 of FIG. 2E by a user selecting the region 214a or the carry-in reservation button 214α or the direct delivery reservation button 214β of FIG. 2B, the wine A may be automatically put in the cart in response to the selection of the reservation button 241.

FIG. 2F shows a screen 250 displayed on a user apparatus. The screen 250 is an example of a store wine list screen for presenting a wine list of a store. The screen 250 is, for example, a screen that has transitioned from the screen 210 by selecting the region 215a shown in FIG. 2B. In the example shown in FIG. 2F, the screen 250 presents a while list of the store A. In the example shown in FIG. 2F, the screen 250 comprises a reservation button 241, wine carry-in information 242, wine direct delivery information 243 and list wine reservation button 251 for reserving wine listed in the wine list.

In the example shown in FIG. 2F, the wine list of the store A comprises wine A with the price “12345 yen”, wine X with the price “60000 yen” and wine Y with the price “45000 yen”. When the list wine reservation button 251 in the wine list is selected by a user, the screen 250 transitions to a screen for simultaneously reserving both the wine A and the store A. This enables the user to easily make reservation of both the wine A and the store A.

FIG. 2G shows a screen 260 displayed on a user apparatus. The screen 260 is an example of a store search screen for searching a store. In the example shown in FIG. 2G, the screen 260 comprises a condition input region 261 for inputting the search condition “area”, a condition input area 262 for inputting the search condition “genre”, a search button 263 for initiating search of a store based on the inputted search conditions and a search result region 264 where the search result is presented.

In the example shown in FIG. 2G, regarding the condition input region 261 and the condition input region 262, a search condition can be selected in a pull-down form, wherein the search result of stores with the area “Shibuya/Omotesando/Aoyama” as a search condition is displayed in the search result area 264 of FIG. 2G. In the example shown in FIG. 2G, the search result region 264 comprises a region 264a showing information of a store A that satisfies the search condition, a region 264b showing information of a store B that satisfies the search condition, a region 264c showing information of a store C that satisfies the search condition and a region 264d showing information of a store D that satisfies the search condition.

When the region 264a shown in FIG. 2G is selected by a user, for example, the screen would transition from the screen 260 of FIG. 2G to the screen 240 of FIG. 2E or the screen 250 of FIG. 2F. When the screen transitions from the screen 260 of FIG. 2G to the screen 250 of FIG. 2F, the user can simultaneously carry out reservation of the store A and reservation of the wine A by selecting the list wine reservation button 251 on the screen 250.

In addition, in the example shown in FIG. 2B, food that matches with the wine A is presented in a state of being associated with the stores that can provide the food in the food information region 212, but the present invention is not limited thereto. For example, in the user information region 212 of FIG. 2B, only one or more food that matches with the wine A may be presented to a user in the food information region 212 and then, when one among the presented one or more food is selected by a user, the screen 210 may transition to a screen presenting information of a store that can provide the selected food. This enables the user to select desired wine, food that matches with the desired wine and a store that cam provide the food that matches with the desired wine in that order.

In addition, in the embodiment shown in FIG. 2A, two bottles of recommended wine and two bottles of new wine are displayed on the screen 200, but the present invention is not limited thereto. In the screen 200, the number of wine displayed as recommended wine and the number of wine displayed as new wine are any integral number that is 1 or higher.

In addition, in the embodiment shown in FIG. 2B, three types of food that matches with the wine A and three types of stores where the wine A can be drunk are displayed on the screen 210, but the present invention is not limited thereto. The number of food that matches the wine A and the number of stored where the wine A can be drunk displayed on the screen 210 are any integral number that is 1 or higher.

In addition, in the embodiment shown in FIG. 2D, six stores that can provide food that matches with the wine A are displayed on the screen 230, but the present invention is not limited thereto. The number of stores that provide food that matches with the wine A displayed on the screen 230 is any integral number that is 1 or higher.

In addition, in the embodiment shown in FIG. 2F, three bottles of wine of the store A are displayed in a list on the screen 250, but the present invention is not limited thereof. The number of wine of the store A displayed in a list on the screen 250 is any integral number that is 1 or higher.

In addition, in the embodiment shown in FIG. 2G, four stores are displayed as search result of stores on the screen 260, but the present invention is not limited thereto. The number of stores displayed on the screen 260 as a search result of stores is any integral number that is 1 or higher. In addition, in the embodiment shown in FIG. 2G, there are “area” and “genre” as categories of the search conditions, but the present invention is not limited thereto. Any number of any category can be set as a search condition of stores.

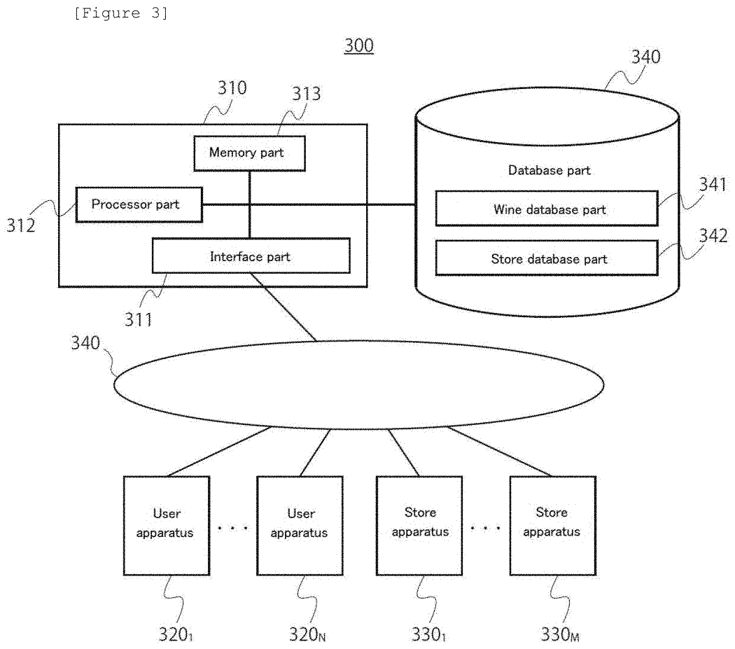

3. Configuration of a Computer System for Realizing a New Business Model FIG. 3 shows an example of a configuration of a computer system 300 for realizing the new business model discussed above.

In the embodiment shown in FIG. 3, the computer system 300 is configured so as to enable connection to at least one user apparatus 320₁ to 320_{N} used by a user and at least one store apparatus 330₁ to 330_{M} used by a store via the internet 310. Herein, M and N are any integral number that is 1 or higher.

The computer system 300 is administered/managed by a wholesaler. In the embodiment shown in FIG. 3, the computer system 300 comprises an interface part 301, a processor part 302 including one or more CPU (Central Processing Unit) and a memory part 303. The hardware configuration of the computer system 300 is not particularly limited as long as the function thereof is realized and the hardware configuration of the computer system 300 can be configured with a single machine or configure by combining a plurality of machines.

The interface part 301 controls communication between the at least one user apparatus 320₁ to 320_{N} and the at least one store apparatus 330₁ to 330_{M}.

The memory part 303 houses a program required for performing a processing, data required for performing the program and the like. In this regard, it does not matter how a program is housed in the memory part 303. For example, a program can be preinstalled in the memory part 303. Alternatively, a program can be installed in the memory part 303 by being downloaded via a network such as the internet 310, or a program can be installed in the memory part 303 through a storage medium such as an optical disk or a USB.

The processor part 302 controls the operation of the entirety of the computer system 300. The processor part 302 reads the program housed in the memory part 303 and performs the program. This enables the computer system 300 to function as an apparatus performing a desired step and enables the computer system 300 to function as a web server providing a website.

A database part 340 is connected to the computer system 300. The database part 340 comprises a wine database part 341 and a store database part 342.

Each of the at least one user apparatus 320₁ to 320_{N} is configured so as to enable communication with the computer system 300 via the internet 310. For example, each of the at least of user apparatus 320₁ to 320_{N} can be a portable wireless terminal such as a cell phone, smartphone, tablet terminal, smart glass or smart watch terminal, or a personal computer such as a desktop PC, laptop PC or note PC.

Each of the at least one store apparatus 330₁ to 330_{M} is configured to enable communication with the computer system 300 via the internet 310. For example, each of the at least one store apparatus 330₁ to 330_{M} can be a management apparatus that comprehensively manages consumption of each store, or can be a register using a POS system (sales time point information management system).

In addition, in the embodiment shown in FIG. 3, it is explained that the at least one user apparatus 320₁ to 320_{N} can communicate with the computer system 300 via the internet 310, but the present invention is not limited thereto. It is possible to use any type of network instead of the internet 310. In addition, a configuration that electrically binds the at least one user apparatus 320₁ to 320_{N} to the computer system 300 without going through the internet 310 or any alternative network is also within the scope of the present invention. Furthermore, a system uniformly incorporating both the function of a user apparatus 320₁ and the function of a computer system 300 (i.e., stand-alone type system) may be constricted as the computer system 300. Such a stand-alone type computer system 300 is also within the scope of the present invention.

In addition, in the embodiment shown in FIG. 3, the database part 340 is provided outside the computer system 300, but the present invention is not limited thereto. It is also possible to provide the database part 340 inside the computer system 300. The configuration of the database part 340 is not limited to a specific hardware configuration. For example, the database part 340 can be configured with a single hardware part, or can be configured with a plurality of hardware parts. For example, the database part 340 can be configured as a single external hard disk apparatus of the computer system 300, or can be configured as a storage on a cloud connected through a network. Furthermore, the configuration of each database part comprised in the database part 340 is also not limited to a specific hardware configuration. For example, each database part comprised in the database part 340 can be configured with a single hardware part, or can be configured with a plurality of hardware parts.

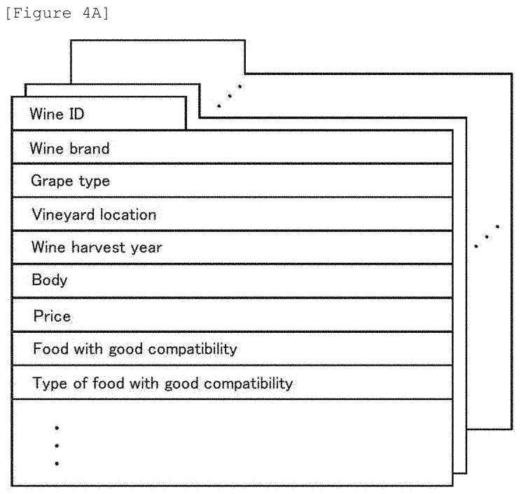

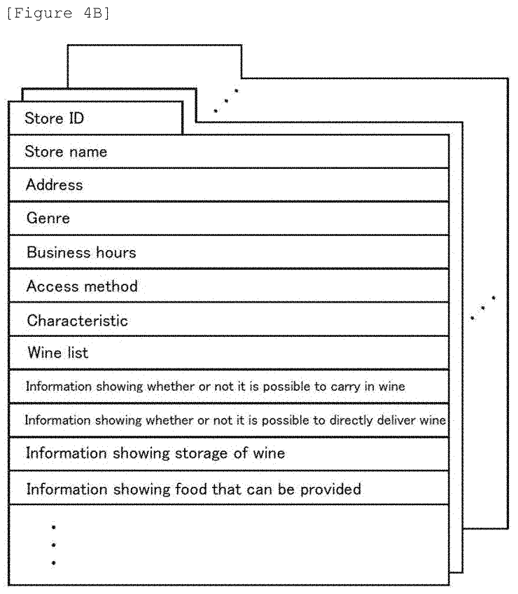

FIG. 4A shows an example of a configuration of information housed in the wine database part 341.

Information regarding wine is housed in the wine database part 341. The information regarding wine can be identified by information for identifying wine (wine ID). For example, wine brand (variety), grape type (type), vineyard location (production area), wine harvest year (vintage), body, price, food with good compatibility, type of food with good compatibility and the like are further housed in the wine database part 341.

The information regarding wine housed in the wine database part 341 is not limited to information of wine that can be provided by a specific store. The information regarding wine housed in the wine database part 341 may comprise at least a part of information of wine owned by a wholesaler which sets a plurality of stores as wholesale destinations. The information regarding wine housed in the wine database part 341 may comprise at least a part of information of wine owned by a stocking dealer (importer) that is a stocking destination of a wholesaler. This enables the computer system 300 to present a user with information of wine owned by the wholesaler and information of wine owned by the stocking dealer. Therefore, a customer can examine various wine with rich variation without the choices of wine being limited to the storage of a specific store.

FIG. 4B shows an example of a configuration of information housed in the store database part 342.

Information regarding a store is housed in the store database part 342. The information regarding a store can be identified by information for identifying a store (store ID). For example, store name, address, genre, business hours, access method, characteristic, wine list listing wine that can be provided to a user (customer), information showing whether or not it is possible to carry in wine, information showing whether or not it is possible to directly deliver wine, information showing storage of wine, information showing food that can be provided and the like are further housed in the store database part 342.

The computer system 300 can realize presenting of information of a store that can provide food with good compatibility with specific wine by, for example, referring to the “food with good compatibility” in the wine database part 341 and the “information showing food that can be provided” in the store database part 342.

### 4. Processing of Computer System

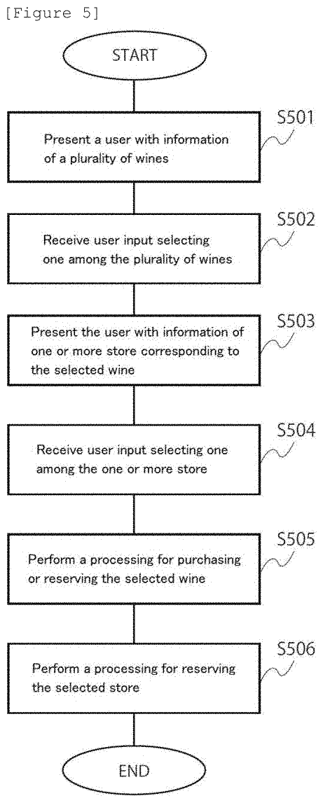

FIG. 5 shows an example of a flow of the processing performed in the computer system 300. In the embodiment shown in FIG. 5, a user selects a wine that the user wants to drink and then selects a store that the user wants to go. Each step shown in FIG. 5 is performed by the processor part 302 comprised in the computer system 300. Each step shown in FIG. 5 is explained below in detail.

Step S501: A processing for presenting a user with information of a plurality of wines. This processing comprises, for example, the processing of having a user apparatus carry out presenting of the information of a plurality of wines to the user. This step corresponds to the screen 200 shown in FIG. 2A. The information of a plurality of wines presented in this step is, for example, information of wine housed in the wine database part 341 (e.g., information of wine owned by a wholesaler and/or information of wine owned by a stocking dealer that is a stocking destination of the wholesaler).

In addition, the information of a plurality of wines may be information of a plurality of wines provided to a user at a normal time, or may be real-time information of a plurality of wines. In other words, the processor part 302 of the computer system 300 may be configured to enable real time update of information of a plurality of wines presented to a user (e.g., based on information showing consumption of wine in each store and/or information showing stacking of wine by a wholesaler).

Step S502: A processing for receiving user input selecting one among the plurality of wines is performed. This step corresponds to, for example, the selection of the region 202 shown in the screen 200 of FIG. 2A. The user input selecting one among the plurality of wines is, for example, received from a user apparatus used by the user.

Step S503: A processing for presenting the user with information of one or more store corresponding to the selected wine is performed. This processing comprises, for example, the processing of having the user apparatus carry out presenting of information of one or more store corresponding to the selected wine to the user. This step corresponds to the screen 210 shown in FIG. 2B or the screen 230 shown in FIG. 2D.

The one or more store corresponding to the selected wine comprises, for example, but not limited to, one or more store that can provide the user with food that matches with the selected wine, one or more store that can provide the user with the selected wine and one or more store that can provide both the selected wine and food that matches with the selected wine.

Step S504: A processing for receiving the user input selecting one among the one or more store corresponding to the selected wine is performed. This step corresponds to selection of, for example, any of the region 214a, region 214b, region 214c, carry-in reservation button 214α, direct delivery reservation button 214β, region 215a, region 215d and region 215e shown in the screen 210 of FIG. 2B, or any of the region 231a, region 231b, region 231c, region 231f, region 231g and region 231h shown in the screen 230 of FIG. 2D. The user input selecting one among one or more store corresponding to the selected wine is, for example, received from the user apparatus used by the user.

Step S505: A processing for purchasing or reserving the selected wine is performed. This step corresponds to selection of, for example, the carry-in reservation button 214α or direct delivery reservation button 214β shown in the screen 210 of FIG. 2B, or the reservation button 241 shown in the screen 240 of FIG. 2E and the screen 250 of FIG. 2F, or the list wine reservation button 251 shown in the screen 250 of FIG. 2F.

Step S506: A processing for reserving the selected store is performed. The processing for reserving the selected store comprises, for example, a processing for reserving the selected store which assumes carry-in of the selected wine to the selected store and a processing for reserving the selected store which assumes direct delivery of the selected wine to the selected store.

The processing for reserving the selected store which assumes carry-in of the selected wine to the selected store comprises, for example, a processing for setting a flag for charging the carry-in fee of wine to the user reserving the selected store, and the like. The processing for reserving the selected store which assumes direct delivery of the selected wine to the selected store comprises, for example, a processing for associating reservation information of the user reserving the selected store and delivery information of the selected wine in order to associate the directly delivered wine and the user who made the reservation, and the like.

In addition, in the embodiment shown in FIG. 5, an example of performing the presenting of information of a store after presenting information of wine is exampled, but the present invention is not limited thereto. The processor part 302 of the computer 300 may be, for example, configured to further perform presenting of a user with information of one or more food that matches with the selected wine in response to receipt of the user input in step S502 and receiving of the user input selecting one among the one or more food that matches with the selected wine, and may be configured to further perform presenting of information of one or more store that can provide the user with the selected food to the user in response to receiving the user input selecting one among the one or more food that matches with the selected wine in step S503.

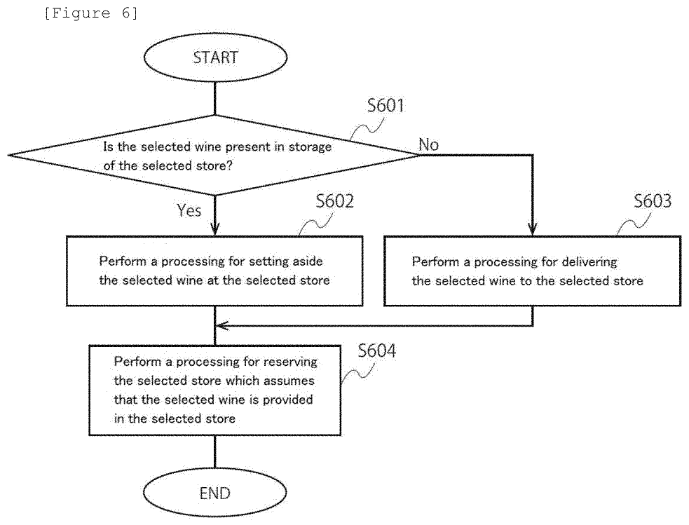

FIG. 6 shows another example of the flow of the processing performed in the computer system 300. Each step shown in FIG. 6 is an example of the detailed flow of step S506 shown in FIG. 5. In the embodiment shown in FIG. 6, a user wishes to drink desired wine in a desired store. Each step shown in FIG. 6 is explained below in detail.

Step S601: A processing for determining whether or not the wine selected in step S502 of FIG. 5 exists in storage of the store selected in step S504 of FIG. 5 is performed. This processing is performed, for example, based on information showing storage of wine housed in the store database part 342. When the determination result is “Yes”, the processing proceeds to step S602, and when the determination result is “No”, the processing proceeds to step S603.

Step S602: A processing for setting aside the selected wine at the selected store in order to provide the user with the selected wine in the selected store. The processing for setting aside the selected wine at the selected store comprises, for example, a processing for updating information showing storage of the selected wine in the selected store so as to reduce the store of the selected wine in the selected store.

Step S603: A processing for delivering the selected wine to the selected store is performed in order to present the user with the selected wine in the selected store. The processing for delivering the selected wine to the selected store comprises, for example, a processing for arranging delivery of the selected wine to the selected store.

Step S604: A processing for reserving the selected store which assumes that the selected wine is provided in the selected store is performed. This processing comprises, for example, a processing for generating reservation information of the selected store so as to associate with the information of the wine that is set aside or the delivery information of the delivered wine.

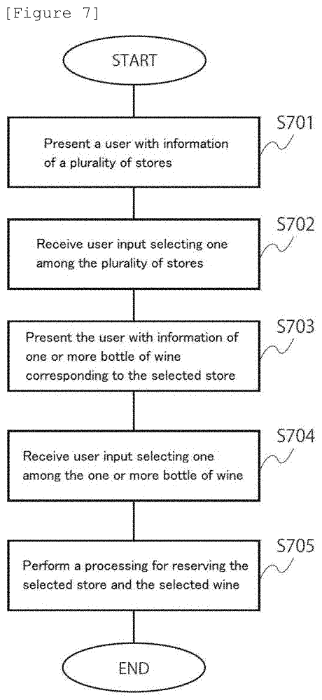

FIG. 7 shows an example of the flow of the processing performed in the computer system 300. In the embodiment shown in FIG. 7, the user selects a store that the user wants to go and then selects wine that the user wants to drink. Each step shown in FIG. 7 is performed by the processor part 302 comprised in the computer system 300. Each step shown in FIG. 7 is explained below in detail.

Step S701: A processing for presenting the user with information of a plurality of stores is performed. This processing comprises, for example, the processing that has the user apparatus present the information of a plurality of stores to the user.

Step S702: A processing for receiving the user input of selecting one among a plurality of stores is performed. This step corresponds to, for example, selecting any of the region 264a, region 264b, region 264c and region 264 shown in the screen 260 of the FIG. 2G. The user input of selecting one among a plurality of stores is, for example, received from the user apparatus used by the user.

Step S703: A processing for presenting the user with information of one or more bottle of wine corresponding to the selected store is performed. This processing comprises, for example, the processing of having the user apparatus present the user with information of one or more bottle of wine corresponding to the selected store. This step corresponds to the screen 250 shown in FIG. 2F.

The one or more bottle of wine corresponding to the selected store comprises, for example, one or more bottle of wine drunk by the user in the selected store (e.g., one or more bottle of wine present in storage of the selected store, one or more bottle of wine that (is not present in storage of the selected store but) can be provided to the user in the selected store by delivery to the selected store, one or more bottle of wine (which is not present in storage of the selected store but) drunk by the user in the selected store by delivery to the selected store and the like). The one or more bottle of wine corresponding to the selected store comprises one or more bottle of wine at least owned by a wholesaler which sets a plurality of stores as wholesale destinations (e.g., wine owned by the wholesaler and/or wine owned by a stocking dealer that is the stocking destination of the wholesaler).

Step S704: A processing for receiving the user input of selecting one among the one or more bottle of wine corresponding to the selected store is performed. This step corresponds to, for example, selection of the list wine reservation button 251 shown in the screen 250 of FIG. 2F. The user input of selecting one among the one or more bottle of wine corresponding to the selected store is, for example, received from the user apparatus used by the user.

Step S705: A processing for reserving the selected store and the selected wine is performed. This processing comprises, for example, a processing for generating reservation information in the selected store (reservation information including information of the selected wine that should be provided to the user).

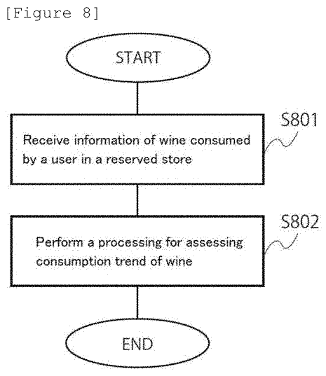

FIG. 8 shows an example of the flow of the processing performed in the computer system 300. Each step shown in FIG. 8 is performed by the processor part 302 comprised in the computer system 300. Each step shown in FIG. 8 is explained below in detail.

Step S801: A processing for receiving information of the wine consumed by the user (e.g., in the reserved store). The information of the wine consumed by the user is, for example, received from the store apparatus in the reserved store. Furthermore, the wine consumed by the user may comprise wine selected by the user upon reservation of the wine and wine carried in the reserved store or wine delivered to the reserved store or wine present the storage of the reserved store.

Step S802: A processing for assessing consumption trend of wine including purchased or reserved wine based on the information of the wine consumed by the user. The processing for assessing consumption trend of wine comprises, for example, a processing for statistically analyzing information of the wine consumed by the user, a processing for summarizing information of the wine consumed by the user into a graph, and the like.

As such, the wholesaler (computer system 300) not only can utilize the information of the wine consumed by the user in the reserved store to identify the consumption trend of wine (e.g., wine in season, popular wine), but also can attempt optimization of stocking of wine, optimization of selection of wine in each store and the like.

In addition, in the embodiment shown in FIG. 5 to FIG. 8 explained an example of realizing the processing of each step shown in FIG. 5 to FIG. 8 by the processor part performing the program housed in the memory part, but the present invention is not limited thereto. At least a part of the processing of each step shown in FIG. 5 to FIG. 8 may be realized by a hardware configuration such as a control circuit.

Although the present invention has been exemplified using a preferable embodiment of the present invention as described above, the interpretation of the present invention should not be limited to this embodiment. It is understood that the scope of the present invention should be interpreted by the Claims alone. It is understood that those skilled in the art can practice an equivalent scope based on the description of the present invention and common general knowledge from the description of the specific and preferable embodiment of the present application.

### INDUSTRIAL APPLICABILITY

The present invention is useful as an invention that provides a system for purchasing or reserving wine, a method and program implemented in said system and the like so as to enable the user to drink the wine the user wants to drink in a reserved store.

### REFERENCE SIGNS LIST

300 computer system
310 internet
320₁ to 320_{N} user apparatus
330₁ to 330_{M} store apparatus
340 database part

1.-20. (canceled)

21. A system for purchasing or reserving wine, the system comprising:
a means of presenting a user with information of a plurality of wines;
a means of receiving first user input selecting one among the plurality of wines;
a means of presenting, in response to receiving the first user input, information of one or more food that matches with the selected wine;
a means of receiving third user input selecting one among the one or more food;
a means of presenting, in response to receiving the third user input, the user with information of one or more store that can provide the user with the selected food;
a means of receiving second user input selecting one among the one or more store; and
a means of performing, in response to receiving the second user input, a processing for purchasing or reserving the selected wine in order to provide the user with the selected wine in the selected store.

22. The system of claim 21, further comprising a means of performing a processing for reserving the selected store.

23. The system of claim 22, wherein the processing for reserving the selected store comprises a processing for reserving the selected store which assumes carry-in of the selected wine to the selected store or a processing for reserving the selected store which assumes delivery of the selected wine to the selected store.

24. The system of claim 22, wherein the processing for reserving the selected store comprises:
a processing for determining whether or not the selected wine is present in storage of the selected store;
a processing for setting aside the selected wine at the selected store when it is determined that the selected wine is present in storage of the selected store; and
a processing of reserving the selected store which assumes that the selected wine is provided in the selected store.

25. The system of claim 21, wherein:
the plurality of wines comprise a plurality of wines at least owned by a wholesaler which sets a plurality of stores as wholesale destinations; and
the plurality of stores comprise the one or more store.

26. The system of claim 25, wherein the plurality of wines at least owned by the wholesaler comprises wine owned by the wholesaler and wine owned by a stocking dealer that is a stocking destination of the wholesaler.

27. The system of claim 21, further comprising a means of updating information of the plurality of wines presented to the user in real time.

28. The system of claim 21, further comprising:
a means of receiving information of wine consumed by the user in the reserved store, wherein the wine consumed by the user comprises the purchased or reserved wine and wine carried in the reserved store or wine delivered to the reserved store or wine present in storage of the reserved store; and
a means of performing a processing for assessing consumption trend of wine based on the information of wine consumed by the user.

29. A method performed in a system for purchasing or reserving wine, wherein the system comprises a processor part, wherein the method comprises:
the processor part presenting a user with information of a plurality of wines;
the processor part receiving first user input selecting one among the plurality of wines;
the processor part presenting, in response to receiving the first user input, information of one or more food that matches with the selected wine;
the processor part receiving third user input selecting one among the one or more food;
the processor part presenting, in response to receiving the third user input, the user with information of one or more store that can provide the user with the selected food;
the processor part receiving second user input selecting one among the one or more store; and
the processor part performing, in response to receiving the second user input, a processing for purchasing or reserving the selected wine in order to provide the user with the selected wine in the selected store.

30. A program performed in a system for purchasing or reserving wine, wherein the system comprises a processor part, wherein when performed by the processor part, the program causes the processor part to at least perform:
presenting a user with information of a plurality of wines;
receiving first user input selecting one among the plurality of wines;
presenting, in response to receiving the first user input, information of one or more food that matches with the selected wine;
receiving third user input selecting one among the one or more food;
presenting, in response to receiving the third user input, the user with information of one or more store that can provide the user with the selected food;
receiving second user input selecting one among the one or more store; and
performing, in response to receiving the second user input, a processing for purchasing or reserving the selected wine in order to provide the user with the selected wine in the selected store.
